(19) United States
(12) Patent Application Publication
(10) Pub. No.: US 2025/0061586 A1
(43) Pub. Date: Feb. 20, 2025

(54) IMAGE PROCESSING METHOD AND APPARATUS, AND ELECTRONIC DEVICE AND STORAGE MEDIUM

(71) Applicant: Beijing Zitiao Network Technology Co., Ltd., Beijing (CN)

(72) Inventors: Guangwei WANG, Beijing (CN); Xiaoxu LENG, Beijing (CN); Qiang ZHAO, Beijing (CN); Yongjie ZHANG, Beijing (CN)

(21) Appl. No.: 18/725,721

(22) PCT Filed: Dec. 26, 2022
(86) PCT No.: PCT/CN2022/141779

§ 371 Date: Jun. 28, 2024

(30) Foreign Application Priority Data
Dec. 28, 2021 (CN) 202111629516.9

(51) Int. Cl. G06T 7/20; G06T 7/11; G06V 10/75

(52) U.S. Cl. CPC G06T 7/20; G06T 7/11; G06V 10/751

(57) ABSTRACT

An image processing method and apparatus, an electronic device, and a storage medium. The method includes: determining a target drawing viewpoint corresponding to a trigger operation on a target object when the trigger operation is detected; determining a target grid region to which the target drawing viewpoint belongs based on a pre-generated target sphere grid model, and determining a target interpolation image corresponding to the target drawing viewpoint according to at least one optical flow information set of the target grid region; and issuing the target interpolation image to a target client, so as to display, on the target client, the target interpolation image corresponding to the trigger operation.

The application claims the priority of Chinese Patent Application No. 202111629516.9 filed on Dec. 28, 2021, the entire contents of which are incorporated herein by reference as a part of this application.

### TECHNICAL FIELD

The present disclosure relates to the technical field of image processing, for example, to an image processing method and apparatus, an electronic device, and a storage medium.

### BACKGROUND

In order to improve the impression rate of items, the items can be displayed in multiple dimensions through different Internet platforms.

In order to realize multi-dimensional display, a three-dimensional (3D) model corresponding to the target object can be made and displayed on the display interface. According to the user's dragging operation on the 3D model, the viewing angle to be rendered is determined, and then the view under the corresponding viewing angle is obtained. In this case, it is necessary to render the views from different viewing angles, which requires high performance of image displaying devices and involves poor universality.

In order to solve the above problems, it's also possible to adopt the way of rendering and storing the views from different viewing angles. If the storage space is limited, it can't store the views from multiple viewing angles. Accordingly, when the user drags the 3D model, the view closest to the current dragging angle can be determined from a plurality of stored views, and this view will be sent to the client for display, which results in considerable difference between the view as displayed and the view that the user actually expects to watch, thus causing the problem of poor user experience.

### SUMMARY

The present disclosure provides an image processing method, an image processing apparatus, an electronic device and a storage medium, so as to achieve the technical effect of quickly and conveniently determining a target view under a corresponding viewpoint and displaying the target view.

In a first aspect, the present disclosure provides an image processing method, including:
determining a target drawing viewpoint corresponding to a trigger operation in response to detecting the trigger operation on a target object;
determining a target grid region to which the target drawing viewpoint belongs based on a pre-generated target sphere grid model, and determining a target interpolation image corresponding to the target drawing viewpoint according to at least one optical flow information set of the target grid region; and
sending the target interpolation image to a target client, so as to display the target interpolation image corresponding to the trigger operation on the target client.

In a second aspect, the present disclosure also provides an image processing apparatus, including:
a target drawing viewpoint determination module, configured to determine a target drawing viewpoint corresponding to a trigger operation in response to detecting the trigger operation on a target object;
a target interpolation image determination module, configured to determine a
target grid region to which the target drawing viewpoint belongs based on a pre-generated target sphere grid model, and determine a target interpolation image corresponding to the target drawing viewpoint according to at least one optical flow information set of the target grid region; and
an image display module, configured to send the target interpolation image to a target client, so as to display the target interpolation image corresponding to the trigger operation on the target client.

In a third aspect, the present disclosure also provides an electronic device, including:
one or more processors; and
a storage device on which one or more programs are stored,
when the one or more programs are executed by the one or more processors, the one or more processors realize the image processing method described above.

In a fourth aspect, the present disclosure also provides a storage medium including computer-executable instructions, the computer-executable instructions, when executed by a computer processor, perform the image processing method described above.

In a fifth aspect, the present disclosure also provides a computer program product including a computer program carried on a non-transient computer-readable medium, the computer program includes program codes for performing the image processing method described above.

### BRIEF DESCRIPTION OF DRAWINGS

FIG. 1 is a flowchart of an image processing method provided by a first embodiment of the present disclosure;

FIG. 2 is a flow chart of an image processing method provided by a second embodiment of the present disclosure;

FIG. 3 is a schematic diagram of a to-be-processed sphere grid model provided by a second embodiment of the present disclosure;

FIG. 4 is a flow chart of an image processing method provided by a third embodiment of the present disclosure;

FIG. 5 is a schematic structural diagram of an image processing apparatus provided in a fourth embodiment of the present disclosure; and

FIG. 6 is a schematic structural diagram of an electronic device provided by a fifth embodiment of the present disclosure.

### DETAILED DESCRIPTION

Embodiments of the present disclosure will be described below with reference to the accompanying drawings. Although some embodiments of the present disclosure are shown in the drawings, it should be understood that the present disclosure can be embodied in various forms and these embodiments are provided for an understanding of the present disclosure. The drawings and embodiments of the present disclosure are only used for illustrative purposes.

The plurality of steps described in the method embodiments of the present disclosure may be performed in a different order and/or in parallel. Furthermore, additional steps may be added into or certain steps may be omitted from the method embodiments. The scope of the present disclosure is not limited in this respect.

As used herein, the term “comprising/including” and its variants are open-ended, that is, “comprising/including but not limited to”. The term “based on” refers to “at least partially based on”. The term “one embodiment” refers to “at least one embodiment”; the term “another embodiment” refers to “at least one other embodiment”; the term “some embodiments” refers to “at least some embodiments”. Related definitions of other terms will be given in the following description.

The concepts of “first”, “second” and the like mentioned in the present disclosure are only used to distinguish different devices, modules or units, and are not used to limit the order or interdependence of the functions performed by these devices, modules or units. It should be noted that the wordings “a/an/one” and “a plurality of/multiple” mentioned in the present disclosure are schematic rather than limiting, and those skilled in the art should understand that unless the context indicates otherwise, they should be understood as “one or more”.

Names of messages or information exchanged among multiple devices in the embodiments of the present disclosure are only used for illustrative purposes, and are not used to limit the scope of these messages or information.

Before introducing the technical solution, the application scenario will be exemplified first. The present technical solution can be applied to any scenario that needs to display an item and is supported by the Internet, for example, a scenario where a three-dimensional model of an item is displayed on a display interface of a shopping platform, and a view of the item at a corresponding viewpoint is determined according to the user's trigger operation and then is displayed. It can also be a scenario in which the corresponding items can be displayed according to the user's dragging operation in a short video scene.

### First Embodiment

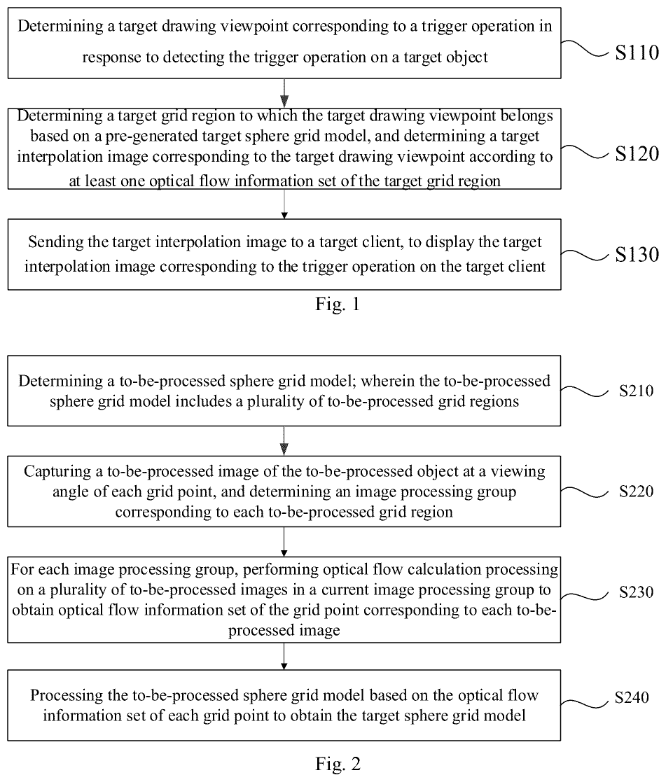

FIG. 1 is a flow chart of an image processing method provided by the first embodiment of the present disclosure. This embodiment can be applied to the situation that the target views at different viewpoints can be determined and displayed according to the viewing angles of the target object relative to the user in various image display scenes supported by the Internet. This method can be implemented by an image processing apparatus, which can be implemented in the form of software and/or hardware, and the hardware can be an electronic device, such as a mobile terminal, a personal computer (PC) terminal or a server. Any scene of image display is usually realized by the cooperation of the client and the server, and the method provided in this embodiment can be executed by the server, the client, or the cooperation between the client and the server.

S110, determining a target drawing viewpoint corresponding to a trigger operation in response to detecting the trigger operation on a target object.

The target object can be an item currently displayed, for example, when a ceramic bottle is displayed on a terminal device, the ceramic bottle can be used as the target object. What is displayed on the terminal device can be a 3D model of the target object. The trigger operation can be understood as a sliding or dragging operation specific to the 3D model of the target object. When sliding the display screen, the 3D model of the target object can be driven to rotate, and different rotation angles correspond to different viewing angles of users. The target drawing viewpoint matches with the user's viewing angle; that is, according to the user's trigger operation, it can be determined the angle at which the user wants to watch at present, and the corresponding viewing angle can be used as the target drawing viewpoint.

When the dragging operation on the target object is detected, the viewing angle of the target object under the dragging operation can be determined, that is, the target drawing viewpoint can be determined.

When the target object rotates, a target sphere grid model corresponding to the target object also rotates, and the target drawing viewpoint corresponding to the target object at this viewing angle can be determined accordingly.

S120, determining a target grid region to which the target drawing viewpoint belongs based on a pre-generated target sphere grid model, and determining a target interpolation image corresponding to the target drawing viewpoint according to at least one optical flow information set of the target grid region.

In order to view the target object from multiple angles, a hollow sphere can be meshed according to corresponding longitude and latitude information to obtain a to-be-processed sphere grid model. After further processing the to-be-processed sphere grid model, the obtained sphere grid model is used as a target sphere grid model. The target sphere grid model can be a general sphere grid model obtained after processing the to-be-processed grid model; or, the target sphere grid model is a sphere grid model generated based on the target object. The target object can be taken as the center point of the target sphere grid model. The grid region corresponding to the target drawing viewpoint is taken as the target grid region. Each grid region is composed of four grid points, and each grid point can have corresponding optical flow information. Optical flow information is an instantaneous velocity of pixel motion on an observation imaging plane for a spatially moving object. The optical flow information is determined based on an optical flow method. The optical flow method is to find the corresponding relationship between a previous frame and a current frame by using the change of pixels of the image sequence in time domain and the correlation between adjacent frames, so as to calculate the motion information of the object between adjacent frames. In short, the so-called optical flow is the instantaneous velocity, which is equivalent to the displacement of the target point in the case of small time interval. The target interpolation image can be a view which is drawn based on the optical flow information of four grid points on the target grid region and the corresponding target views; that is, the target interpolation image is a view drawn according to four target views of the grid region to which the target drawing viewpoint belongs and the optical flow information of each of the target views.

Each of the plurality of grid points in the target sphere grid model has a target view corresponding to the target object.

The number of grids in the to-be-processed sphere grid model and the number of grids in the target sphere grid model can be the same or different. If the plurality of grid points in the to-be-processed sphere grid model are properly divided, the to-be-processed sphere grid model is the finally used grid model. If the plurality of grid points in the to-be-processed sphere grid model are not properly divided, the to-be-processed sphere grid model needs to be continuously meshed, so as to obtain the target sphere grid model.

After the target drawing viewpoint is determined, the target grid region to which the target drawing viewpoint belongs can be determined according to the pre-generated target sphere grid model. In this case, each grid region is composed of four grid points, and each grid point stores the target view at the corresponding viewpoint and the predetermined optical flow information. Based on the target views of the four grid points and the corresponding optical flow information, the target interpolation image corresponding to the target drawing viewpoint can be drawn. In the above way, the view completely consistent with the actual viewpoint of watching can be drawn, and the user experience is improved.

S130, sending the target interpolation image to a target client, so as to display the target interpolation image corresponding to the trigger operation on the target client.

The client that displays the target object can be used as the target client.

After determining the target interpolation image, the target interpolation image can be sent to the target client; and after receiving the target interpolation image, the target client can display the target interpolation image on the display interface for users to watch.

As it can be seen from the above, according to the technical solution of the embodiment of the present disclosure, in the case where the number of the views as stored is limited, the views at different viewpoints can be drawn so that the views displayed on the terminal device are completely adapted to the viewing angles of the user, thereby improving the user's viewing experience, that is, satisfying the user's needs as much as possible on the premise of reducing the memory.

According to the technical solution of the embodiments of the present disclosure, when the trigger operation on the target object is detected, the target drawing viewpoint corresponding to the trigger operation can be determined. According to the pre-generated target sphere grid model, the target grid region corresponding to the target drawing viewpoint can be determined, and then the target views and optical flow information of the grid points corresponding to the target grid region can be retrieved. Based on the target views and the corresponding optical flow information, the target interpolation image corresponding to the target drawing viewpoint can be drawn. The method solves the problem that it cannot provide the target view at a specific viewing angle to the user and results in poor user experience in the prior art. According to the target view of each grid point in the target sphere grid model and the corresponding optical flow information, the target interpolation image matched with the target viewpoint can be drawn, that is, the obtained target interpolation image is matched with the user's target viewpoint, thus improving the user's viewing experience.

### Second Embodiment

FIG. 2 is a schematic flow chart of an image processing method provided by the second embodiment of the present disclosure. On the basis of the aforementioned embodiment, a general sphere grid model corresponding to the target object can be determined first, or a target sphere grid model adapted to the target object can be determined. For the determination method, reference can be made to the explanations of the present technical solution, in which the technical terms as same as or corresponding to those in the above embodiment will not be repeated here.

A general sphere grid model corresponding to all of the items can be determined in advance, or, the present technical solution can be repeatedly executed every time when a target object is displayed so as to determine the target sphere grid model corresponding to the target object.

S210, determining a to-be-processed sphere grid model; wherein the to-be-processed sphere grid model includes a plurality of to-be-processed grid regions.

After obtaining the sphere model, the sphere model can be divided according to a preset longitude and latitude division interval, so as to obtain a to-be-processed sphere grid model. For example, the longitude and latitude division interval is 5°. Based on the above method, the sphere model can be divided into a plurality of to-be-processed grid regions to obtain the to-be-processed sphere grid model.

The sphere model can be divided according to the preset longitude and latitude division interval to obtain the to-be-processed sphere grid model. The to-be-processed sphere grid model includes a plurality of to-be-processed grid regions. The to-be-processed sphere grid model is obtained by dividing according to the longitude and latitude information, so each to-be-processed grid region is regarded as one rectangular grid region, and one rectangular grid region corresponds to four grid points. That is, the intersection of a longitude line and a latitude line is regarded as a grid point.

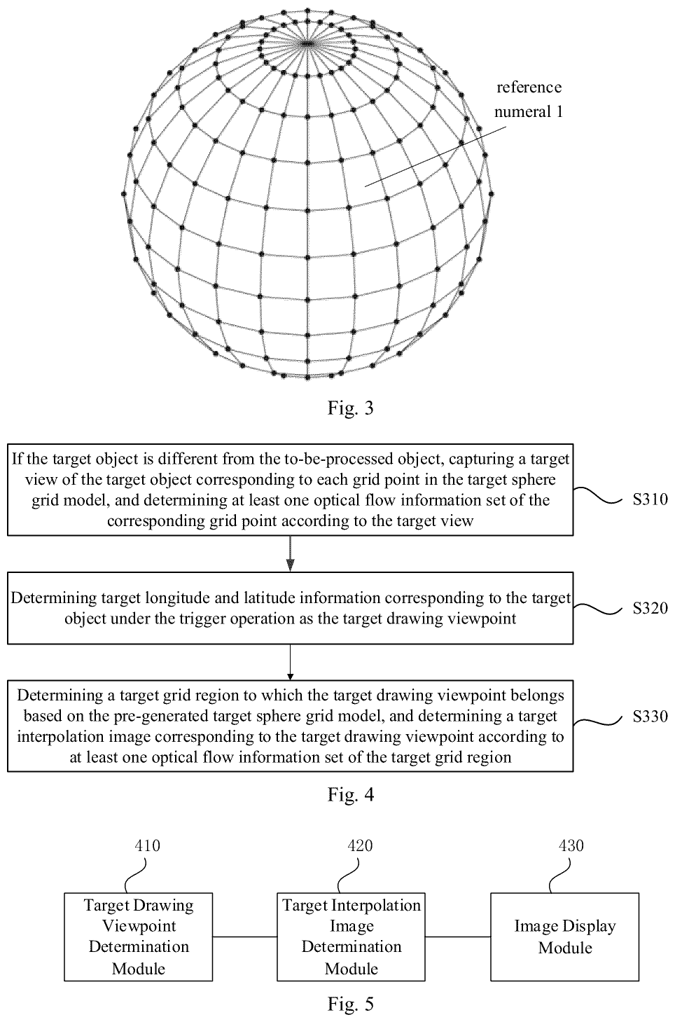

For example, referring to FIG. 3, the to-be-processed object can be regarded as the center point of the hollow sphere, and the hollow sphere can be divided to obtain the to-be-processed sphere grid model as shown in FIG. 3 according to the preset longitude and latitude division interval. The to-be-processed sphere grid model includes a plurality of grid regions, i.e., to-be-processed grid regions, as indicated by reference numeral 1 in FIG. 3.

S220: capturing a to-be-processed image of the to-be-processed object at a viewing angle of each grid point, and determining an image processing group corresponding to each to-be-processed grid region.

The to-be-processed object can be the same as or different from the target object. The to-be-processed object can be deployed at the center point of the sphere grid model. A virtual camera is deployed at each grid point, and the to-be-processed image corresponding to the to-be-processed object is captured based on the virtual camera. Each to-be-processed grid region is composed of four grid points, and correspondingly, each to-be-processed grid region correspond to four to-be-processed images. These four to-be-processed images are regarded as one image processing group. The number of the image processing group is the same as the number of the grid region in the to-be-processed sphere grid model.

The to-be-processed image corresponding to the to-be-processed object can be captured at each grid point, and at the same time, four to-be-processed images for the same grid region can be regarded as one image processing group; in this way, a plurality of image processing groups can be obtained.

S230, for each image processing group, performing optical flow calculation processing on a plurality of to-be-processed images in a current image processing group to obtain optical flow information set of the grid point corresponding to each to-be-processed image.

The processing method is the same for each image processing group and will be introduced with reference to one of the image processing groups by way of example.

The image processing group of the grid region that is being processed currently is regarded as the current image processing group. The optical flow calculation method is used to calculate an instantaneous velocity between every two images in the current image processing group, for example, a longitudinal instantaneous velocity and a latitudinal instantaneous velocity. The longitudinal instantaneous velocity and the latitudinal instantaneous velocity of each to-be-processed image are used as the optical flow information set of the corresponding to-be-processed image.

The optical flow calculation processing is performed on a plurality of to-be-processed images in the current image processing group to obtain the optical flow information set of the grid point corresponding to each to-be-processed image, including the following steps: performing optical flow calculation processing on two to-be-processed images at the same longitude in the current image processing group to determine longitudinal optical flow information corresponding to each to-be-processed image; performing optical flow calculation processing on two to-be-processed images at the same latitude in the current image processing group to determine latitudinal optical flow information corresponding to each to-be-processed image; and determining the optical flow information set of the grid point corresponding to the to-be-processed image according to the longitudinal optical flow information and the latitudinal optical flow information of each to-be-processed image.

Two groups of to-be-processed images located at the same longitude are determined. Each group of to-be-processed images includes two to-be-processed images. For each group of to-be-processed images, the optical flow calculation method is used to determine the instantaneous velocity of two to-be-processed images in the current group of to-be-processed images, that is, the longitudinal optical flow information. Correspondingly, the optical flow information of grid points at latitudes is determined, and the above steps can be repeated to obtain the latitudinal optical flow information corresponding to each grid point. The longitudinal optical flow information and latitudinal optical flow information of each grid point are used as the optical flow information set of each grid point.

S240, processing the to-be-processed sphere grid model based on the optical flow information set of each grid point to obtain the target sphere grid model.

The to-be-processed sphere grid model is pre-generated, and may not be accurate. After obtaining the view and the optical flow information of each grid point, it can be further verified whether the to-be-processed sphere grid model is available.

After determining the optical flow information set of each grid point, the view of any point on the to-be-processed sphere grid model can be determined according to the corresponding optical flow information set. The view generated at this time is determined according to the view and the optical flow information of the grid point on the to-be-processed sphere grid model, and is different, to some extent, from or as same as the view which is actually captured at this viewpoint. According to the comparison result, it can be determined whether to further mesh the to-be-processed sphere grid model, thereby obtaining the target sphere grid model.

In this embodiment, the to-be-processed sphere grid model is processed based on the optical flow information set of each grid point to obtain the target sphere grid model, including: for each to-be-processed grid region, obtaining to-be-processed images and optical flow information sets of four grid points in the current to-be-processed grid region, and determining a to-be-used theoretical view of each to-be-used viewpoint in the current to-be-processed grid region based on the to-be-processed image and the corresponding optical flow information set; performing pixel processing on a to-be-used actual view and the to-be-used theoretical view at the same to-be-used viewpoint to obtain an image pixel difference value corresponding to the to-be-used viewpoint, and determining a pixel average value according to image pixel difference values belonging to the same to-be-processed grid region; wherein the to-be-used actual view is captured at the to-be-used viewpoint; if the pixel average value is not within a preset pixel difference threshold range, the to-be-processed grid region to which the pixel average value belongs is re-meshed until the pixel average value of the re-meshed, to-be-processed grid region is within the preset pixel difference threshold range, thereby obtaining the target sphere grid model.

The to-be-processed grid region can be a grid region on the to-be-processed sphere grid model. For each grid region, there are four to-be-processed images and an optical flow information set corresponding to each to-be-processed image. Through the four to-be-processed images and the corresponding optical flow information sets, the view at any viewpoint in the grid region can be determined, and the view obtained at this time is used as the to-be-used theoretical view. That is, the to-be-used theoretical view is a view corresponding to the to-be-processed object, which is determined according to the to-be-processed images of four grid points in the to-be-processed grid region and the corresponding image processing group. Each viewpoint in the to-be-processed grid region can be used as a to-be-used viewpoint. The to-be-used actual view is a view captured at the corresponding viewpoint by using a virtual camera. By performing pixel point processing on the to-be-used theoretical view and the to-be-used actual view at the same viewpoint, the image pixel difference value can be determined. Each to-be-processed grid region includes a plurality of to-be-used viewpoints, and correspondingly, the image pixel difference value corresponding to each to-be-used viewpoint can be obtained. Through an averaging process to the plurality of image pixel difference values in the same to-be-processed grid region, the pixel average value of each to-be-processed grid region is obtained. If the pixel average value is within the preset pixel difference threshold range, it means that the division of the to-be-processed grid region to which the pixel average value belongs is accurate. If the average pixel value is not within the preset pixel difference threshold range, it means that the to-be-processed grid region to which the average pixel value belongs is unreasonable, and it may not be possible to accurately draw the views at some viewpoints in this grid region. At this time, the to-be-processed grid region can be further meshed by dividing. For example, dividing the to-be-processed grid region into four grid regions, and then sequentially determining whether the pixel average values in the divided, four grid regions satisfy a preset pixel difference threshold, i.e., repeating S210 to S240 until the pixel average values of all the divided, grid regions satisfy the preset pixel difference threshold.

If the pixel average value of the divided, grid region still does not satisfy the preset pixel difference threshold, the grid region can be further meshed by dividing, until the pixel average value of each grid region satisfies the preset pixel difference threshold, thereby obtaining the target grid model.

In order to improve the universality of the to-be-processed grid model or its adaptability to the target object, the number of the to-be-used viewpoints in the to-be-processed grid region can be as large as possible, and correspondingly, the image pixel average value as obtained may be the most accurate.

The target sphere grid model can be obtained based on S210 and S240. The target sphere grid model can be a general sphere grid model applicable for all items; alternatively, when a short video platform receives a target object to be displayed, S210 and S240 can be performed to obtain the target sphere grid model corresponding to the target object.

If it is a general sphere grid model, the area of each grid region can be smaller to adapt the sphere grid model to each object; correspondingly, the number of the grid points will be larger, and the views captured for the target object will be more. In practical application, it consumes less resource to construct a target sphere grid model adapted to the target object. In order to enable the target object and the target sphere grid model to be most suitable without the need of storing huge number of views, the target sphere grid model adapted to the target object can be generated before the target object is displayed, that is, the above steps are repeated by replacing the to-be-processed object with the target object, before the target object is displayed, to construct the target sphere grid model corresponding to the target object, based on which a target interpolation image is determined for displaying.

In the technical solution of the embodiment of the present disclosure, the target sphere grid model can be determined by using the above method, so that when the user drags and watches the target object, the view at each viewpoint can be determined according to the view of each grid point in the target sphere grid model and the corresponding optical flow information set, and the displayed view matches with the viewing angle of the user in the best way, thereby improving the user experience.

### Third Embodiment

FIG. 4 is a schematic flow chart of an image processing method provided by the third embodiment of the present disclosure. On the basis of the aforementioned embodiment, if the target sphere grid model is not determined based on the target object, that is, if the target sphere grid model is a general sphere grid model, a view corresponding to the target object can be captured at each grid point of the general sphere grid model, and an optical flow information set corresponding to each grid point can be determined, and then a target interpolation image can be determined based on the optical flow information set. For its implementation, reference can be made to the explanations of the present technical solution, in which the technical terms as same as or corresponding to those in the above embodiment will not be repeated here.

As shown in FIG. 4, the method includes:

S310, if the target object is different from the to-be-processed object, capturing a target view of the target object corresponding to each grid point in the target sphere grid model, and determining at least one optical flow information set of the corresponding grid point according to the target view.

The target object can be the same as or different from the to-be-processed object. If the target object is the same as the to-be-processed object, the target sphere grid model corresponding to the target object can be determined based on the second embodiment. If the target object is different from the to-be-processed object, it's indicated that the target sphere grid model is a general sphere grid model determined based on the to-be-processed sphere grid model. At this time, the target sphere grid model corresponding to the target object can be determined based on the general target sphere grid model.

If the to-be-processed object is the same as the target object, the determined target sphere grid model can be used as the target sphere grid model of the target object. If the to-be-processed object is different from the target object, the target sphere grid model obtained at this time can be a general sphere grid model. In such case, a target view corresponding to the target object can be captured based on the virtual camera deployed at each grid point, and an optical flow information set corresponding to each target view, i.e., an optical flow information set of each grid point in the target sphere grid model, can be determined.

In order to enable the target sphere grid model and the target object to be most suitable, the target sphere grid model suitable for the target object can be determined before the target object is displayed; that is, the to-be-processed object is consistent with the target object, and a target sphere grid model is generated. Accordingly, if a general target sphere grid model is generated, a target view corresponding to the target object can be captured at each grid point after the target sphere grid model is obtained, and an optical flow information set corresponding to each grid point can be determined by using the above method.

If the target object is the same as the to-be-processed object, the target interpolation image at each viewing angle can be determined based on the first embodiment after the target sphere grid model corresponding to the target object is obtained, and the target interpolation image can be displayed on a display interface of the terminal device.

The target view of the target object is captured at each grid point in the target sphere grid model, and the optical flow information set of the corresponding grid point is determined according to each target view, including: capturing the target view corresponding to the target object at each grid point in the target sphere grid model; performing optical flow calculation processing on the target views of two grid points at the same longitude in each target grid region to obtain the longitudinal optical flow information of the two grid points; performing optical flow calculation processing on the target views of two grid points at the same latitude in each target grid region to obtain the latitudinal optical flow information of the two grid points; and determining a target interpolation view corresponding to the target drawing viewpoint based on the target view, the longitudinal optical flow information and the latitudinal optical flow information of each grid point.

If the target sphere grid model is a general sphere grid model, the target object can be captured at each grid point in the target sphere grid model, and the target view corresponding to each grid point can be obtained. At the same time, an optical flow algorithm can be used to determine the longitudinal and latitudinal optical flow information corresponding to each target view, that is, to determine the longitudinal optical flow information and the latitudinal optical flow information of each grid point. This has the advantage that when the user's dragging operation on the target object is detected, the target drawing viewpoint corresponding to the dragging operation can be determined, and the corresponding target interpolation image can be determined based on the target views of four grid points in the grid region to which the target drawing viewpoint belongs and the corresponding optical flow information sets.

S320, determining target longitude and latitude information corresponding to the target object under the trigger operation as the target drawing viewpoint.

The view corresponding to the target object can be displayed on the terminal device, and the user can watch the target object from different viewing angles by dragging and other operations. Since the terminal device or the server corresponding to the target object does not store the views from multiple viewing angles, the target longitude and latitude information of the target object relative to the target sphere grid model after the dragging operation can be determined. That is, a capturing viewpoint in the target sphere grid model, to which the target object under the dragging operation corresponds, can be used as the target drawing viewpoint.

S330, determining a target grid region to which the target drawing viewpoint belongs based on the pre-generated target sphere grid model, and determining a target interpolation image corresponding to the target drawing viewpoint according to at least one optical flow information set of the target grid region.

In this embodiment, the target grid region can be determined according to the target longitude and latitude information of the target drawing viewpoint; the target view of the grid point in the target grid region and the corresponding at least one optical flow information set can be retrieved; and the target interpolation image corresponding to the target drawing viewpoint can be determined.

The grid region to which the target drawing viewpoint belongs can be used as the target grid region. The target grid region consists of four grid points, each grid point has a target view corresponding to the target object; and at the same time, each grid point also has at least one optical flow information set corresponding thereto. Based on the target views of the four grid points and the corresponding optical flow information sets, the target interpolation image of the target drawing viewpoint can be drawn.

According to the technical solution of the embodiment of the present disclosure, if the target object is different from the to-be-processed object, the target view corresponding to the target object can be captured at each grid point in the target sphere grid model, and the optical flow information set of the corresponding grid point can be determined according to the target view; and when the user's dragging operation on the target object is detected, the target viewing angle information of the target object under the dragging operation, that is, the target drawing viewpoint, is determined; then the target interpolation view is drawn according to the grid region corresponding to the target drawing viewpoint and the corresponding optical flow information set; that is to say, according to the present technical solution, the target interpolation images from different viewing angles can be obtained, so that the view actually browsed by the user is completely adapted to the required viewing angle, and the user experience is further improved.

### Fourth Embodiment

FIG. 5 is a schematic structural diagram of an image processing apparatus provided by the fourth embodiment of the present disclosure. As shown in FIG. 5, the apparatus includes a target drawing viewpoint determination module 410, a target interpolation image determination module 420 and an image display module 430.

The target drawing viewpoint determination module 410 is configured to determine a target drawing viewpoint corresponding to an trigger operation on a target object when the trigger operation is detected; the target interpolation image determination module 420 is configured to determine a target grid region to which the target drawing viewpoint belongs based on a pre-generated target sphere grid model, and determine a target interpolation image corresponding to the target drawing viewpoint according to at least one optical flow information set of the target grid region; the image display module 430 is configured to send the target interpolation image to a target client, so as to display the target interpolation image corresponding to the trigger operation on the target client.

On the basis of the above technical solution, the apparatus further includes:
a grid model pre-processing module, configured to determine a to-be-processed sphere grid model, wherein the to-be-processed sphere grid model includes a plurality of to-be-processed grid regions; an image processing group determination module, configured to capture a to-be-processed image of a to-be-processed object at a viewing angle of each grid point and determine an image processing group corresponding to each to-be-processed grid region, wherein the image processing group includes to-be-processed images of grid points in a same to-be-processed grid region; an optical flow information set determination module, configured to, for each image processing group, obtain an optical flow information set of the grid point corresponding to each to-be-processed image by performing optical flow calculation processing on a plurality of to-be-processed images in a current image processing group; and a grid model determination module, configured to process the to-be-processed sphere grid model based on the optical flow information set of each grid point to obtain the target sphere grid model.

On the basis of the above technical solution, the optical flow information set determination module includes:
a longitudinal optical flow information determining unit, configured to perform optical flow calculation on two to-be-processed images at a same longitude in the current image processing group and determine the longitudinal optical flow information of the two to-be-processed images; a latitudinal optical flow information determining unit, configured to perform optical flow calculation on two to-be-processed images at a same latitude in the current image processing group, and determine the latitudinal optical flow information of the two to-be-processed images; and an optical flow information set determining unit, configured to determine the optical flow information set of the grid point, to which each to-be-processed image corresponds, according to the longitudinal optical flow information and the latitudinal optical flow information of the to-be-processed image.

On the basis of the above technical solution, the grid model determination module includes:

a to-be-used theoretical view determining unit, configured to, for each to-be-processed grid region, determine a to-be-used theoretical view of each to-be-used viewpoint in a current to-be-processed grid region according to the to-be-processed image in the current grid region and the corresponding optical flow information set; a pixel average value determining unit, configured to, for each to-be-processed grid region, perform pixel processing on a to-be-used actual view and the to-be-used theoretical view at a same to-be-used viewpoint in the current to-be-processed grid region to obtain an image pixel difference value corresponding to the to-be-used viewpoint, and determine a pixel average value according to the image pixel difference values belonging to the current to-be-processed grid region, wherein the to-be-used actual view is captured at the to-be-used viewpoint; and a grid model determining unit, configured to re-mesh the to-be-processed grid region to which the pixel average value belongs, by dividing, if the pixel average value is not within the preset pixel difference threshold range, until the pixel average value of the re-divided, to-be-processed grid region is within the preset pixel difference threshold range, to obtain the target sphere grid model.

On the basis of the above technical solution, the apparatus further includes: a first judging module, configured to, if the target object is the same as the to-be-processed object, determine a target interpolation image based on a target view of each grid point in the target sphere grid model and the corresponding optical flow information set; and a second judging module, configured to, if the target object is different from the to-be-processed object, capture a target view including the target object at each grid point in the target sphere grid model and determine an optical flow information set of the corresponding grid point according to each target view, so as to determine the target interpolation image based on the optical flow information set.

On the basis of the above technical solution, the second judging module is further configured to:
capture a target view corresponding to the target object at each grid point in the target sphere grid model; perform optical flow calculation processing on the target views of two grid points at the same longitude in each grid region to obtain longitudinal optical flow information of the two grid points; perform optical flow calculation processing on the target views of two grid points at the same latitude in each grid region to obtain latitudinal optical flow information of the two grid points; and determine the target interpolation view corresponding to the target drawing viewpoint based on the target view, the longitudinal optical flow information and the latitudinal optical flow information of each grid point.

On the basis of the above technical solution, the target drawing viewpoint determination module 410 is further configured to: determine target longitude and latitude information corresponding to the target object under the trigger operation as the target drawing viewpoint.

On the basis of the above technical solution, the target interpolation image determination module 420 is configured to: determine a target grid region according to the target longitude and latitude information of the target drawing viewpoint; retrieve the target view of the grid point in the target grid region and the corresponding at least one optical flow information set, and determine the target interpolation image corresponding to the target drawing viewpoint.

The image processing apparatus provided by the embodiment of the present disclosure can execute the image processing method provided by any embodiment of the present disclosure, and has corresponding functional modules and technical effects.

The various units and modules included in the above apparatus are only divided according to functional logics, but are not limited to the above division, as long as the corresponding functions can be realized; in addition, the names of various functional units are only for the convenience of distinguishing from each other, and are not used to limit the scope of protection of the disclosed embodiments.

### Fifth Embodiment

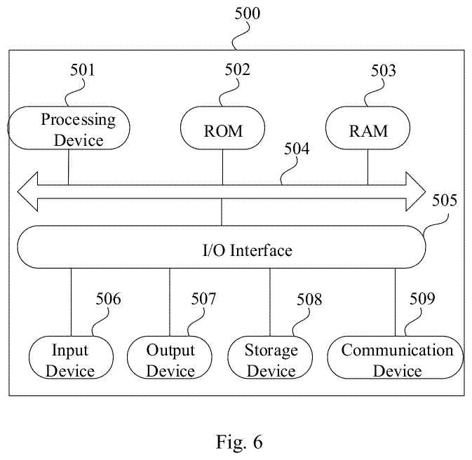

FIG. 6 is a schematic structural diagram of an electronic device provided by the fifth embodiment of the present disclosure. Reference is now made to FIG. 6, which shows a schematic structural diagram of an electronic device (e.g., a terminal device or a server in FIG. 6) 500 suitable for implementing an embodiment of the present disclosure. The terminal device in the embodiment of the present disclosure may include, but not limited to, a mobile terminal such as a mobile phone, a notebook computer, a digital broadcast receiver, a PDA (Personal Digital Assistant), a PAD (Portable Android Device), a PMP (Portable Multimedia Player) and a vehicle-mounted terminal (such as vehicle-mounted navigation terminal), and a fixed terminal such as a digital TV and a desktop computer. The electronic device 500 shown in FIG. 6 is just an example, and should not bring any limitation to the functions and application scopes of the embodiments of the present disclosure.

As shown in FIG. 6, the electronic device 500 may include a processing device (such as a central processing unit, a graphics processor, etc.) 501, which may perform various appropriate actions and processes according to a program stored in a read-only memory (ROM) 502 or a program loaded from a storage device 508 into a random-access memory (RAM) 503. In the RAM 503, various programs and data required for the operation of the electronic device 500 are also stored. The processing device 501, the ROM 502 and the RAM 503 are connected to each other through a bus 504. An input/output (I/O) interface 505 is also connected to the bus 504.

Generally, the following devices can be connected to the I/O interface 505: an input device 506 including, for example, a touch screen, a touch pad, a keyboard, a mouse, a camera, a microphone, an accelerometer, a gyroscope, etc.; an output device 507 including, for example, a liquid crystal display (LCD), a speaker, a vibrator, etc.; a storage device 508 including, for example, a magnetic tape, a hard disk, etc.; and a communication device 509. The communication device 509 may allow the electronic device 500 to communicate wirelessly or wired with other devices to exchange data. Although FIG. 6 shows an electronic device 500 with various devices, it is not required to implement or have all the devices as shown. More or fewer devices may alternatively be implemented or provided.

According to an embodiment of the present disclosure, the process described above with reference to the flowchart can be implemented as a computer software program. For example, an embodiment of the present disclosure includes a computer program product including a computer program carried on a non-transitory computer-readable medium, and the computer program contains program codes for executing the method shown in the flowchart. In such an embodiment, the computer program can be downloaded and installed from the network through the communication device 509, or installed from the storage device 508 or from the ROM 502. When the computer program is executed by the processing device 501, the above functions defined in the method of the embodiment of the present disclosure are performed.

Names of messages or information exchanged among multiple devices in the embodiment of the present disclosure are only used for illustrative purposes, and are not used to limit the scope of these messages or information.

The electronic device provided by the embodiment of present disclosure belongs to the same concept as the image processing method provided by the above embodiment, and the technical details not described in detail in this embodiment can be found in the above embodiment, and this embodiment has the same technical effects as the above embodiment.

### Sixth Embodiment

An embodiment of the present disclosure provides a computer storage medium having a computer program stored thereon, and the computer program, when executed by a processor, realizes the image processing method provided in the above embodiment.

The computer-readable medium mentioned above in the present disclosure can be a computer-readable signal medium or a computer-readable storage medium or any combination of the two. The computer-readable storage medium can be, for example, but not limited to, an electrical, magnetic, optical, electromagnetic, infrared, or semiconductor system, apparatus or device, or a combination of any of the above. Examples of the computer-readable storage medium may include, but are not limited to, an electrical connection with one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, a computer-readable storage medium can be any tangible medium containing or storing a program, which can be used by or in combination with an instruction execution system, apparatus or device. In the present disclosure, a computer-readable signal medium may include a data signal propagated in baseband or as part of a carrier wave, in which computer-readable program codes are carried. This propagated data signal can take many forms, including but not limited to electromagnetic signals, optical signals or any suitable combination of the above. A computer-readable signal medium can also be any computer-readable medium other than a computer-readable storage medium, which can send, propagate or transmit a program for use by or in connection with an instruction execution system, apparatus or device. The program codes contained in the computer-readable medium can be transmitted by any suitable medium, including but not limited to: electrical wires, optical cables, RF (radio frequency) and the like, or any suitable combination of the above.

In some embodiments, the client and the server can communicate by using any currently known or future developed network protocol such as HTTP (HyperText Transfer Protocol), and can be interconnected with digital data communication in any form or medium (for example, communication network). Examples of communication networks include a local area network (“LAN”), a wide area network (“WAN”), the Internet (for example, the Internet) and end-to-end networks (for example, ad hoc end-to-end networks), as well as any currently known or future developed networks.

The computer-readable medium above may be included in the electronic device above; or it can exist alone without being assembled into the electronic device.

The computer-readable medium above carries one or more programs that, when executed by the electronic device, cause the electronic device to:
determine a target drawing viewpoint corresponding to a trigger operation specific to a target object in response to detecting the trigger operation;
determine a target grid region to which the target drawing viewpoint belongs based on a pre-generated target sphere grid model, and determine a target interpolation image corresponding to the target drawing viewpoint according to at least one optical flow information set of the target grid region; and
send the target interpolation image to a target client, so as to display the target interpolation image corresponding to the trigger operation on the target client.

Computer program codes for performing the operations of the present disclosure may be written in one or more programming languages or their combinations, including but not limited to object-oriented programming languages, such as Java, Smalltalk, C++, and conventional procedural programming languages, such as “C” language or similar programming languages. The program code can be completely executed on the user's computer, partially executed on the user's computer, executed as an independent software package, partially executed on the user's computer and partially executed on a remote computer, or completely executed on a remote computer or server. In the case involving a remote computer, the remote computer may be connected to a user's computer through any kind of network, including a local area network (LAN) or a wide area network (WAN), or may be connected to an external computer (for example, through the Internet using an Internet service provider).

The flowcharts and block diagrams in the drawings illustrate the architecture, functions and operations of possible implementations of systems, methods and computer program products according to various embodiments of the present disclosure. In this regard, each block in the flowchart or block diagram may represent a module, a program segment, or a part of code that contains one or more executable instructions for implementing specified logical functions. It should also be noted that in some alternative implementations, the functions annotated in the blocks may occur in a different order than those annotated in the drawings. For example, two blocks shown in succession may actually be executed substantially in parallel, and they may sometimes be executed in the reverse order, depending on the functions involved. It should also be noted that each block in the block diagrams and/or flowcharts, and combinations of blocks in the block diagrams and/or flowcharts, can be implemented by a dedicated hardware-based system that performs specified functions or operations, or by a combination of dedicated hardware and computer instructions.

The units involved in the embodiment described in the present disclosure can be realized by software or hardware. The name of the unit does not constitute the limitation of the unit itself in some cases. For example, the first acquisition unit can also be described as “the unit that acquires at least two Internet protocol addresses”.

The functions described above in the present disclosure may be at least partially performed by one or more hardware logic components. For example, without limitation, exemplary types of hardware logic components that can be used include: Field Programmable Gate Array (FPGA), Application Specific Integrated Circuit (ASIC), Application Specific Standard Product (ASSP), System on Chip (SOC), Complex Programmable Logic Device (CPLD) and so on.

In the context of present disclosure, a machine-readable medium may be a tangible medium that may contain or store a program for use by or in connection with an instruction execution system, apparatus or device. The machine-readable medium may be a machine-readable signal medium or a machine-readable storage medium. A machine-readable medium may include, but is not limited to, an electronic, magnetic, optical, electromagnetic, infrared, or semiconductor system, device or equipment, or any suitable combination of the above. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

According to one or more embodiments of the present disclosure, a first example provides an image processing method, which includes:
determining a target drawing viewpoint corresponding to a trigger operation in response to detecting the trigger operation on a target object;
determining a target grid region to which the target drawing viewpoint belongs based on a pre-generated target sphere grid model, and determining a target interpolation image corresponding to the target drawing viewpoint according to at least one optical flow information set of the target grid region; and
sending the target interpolation image to a target client, so as to display the target interpolation image corresponding to the trigger operation on the target client.

According to one or more embodiments of the present disclosure, a second example provides an image processing method, which further includes:
determining a to-be-processed sphere grid model, the to-be-processed sphere grid model comprising a plurality of to-be-processed grid regions;
capturing a to-be-processed image of a to-be-processed object from a viewing angle of each grid point, and determining an image processing group corresponding to each to-be-processed grid region, the image processing group comprising to-be-processed images of grid points in a same to-be-processed grid region;
for each image processing group, obtaining an optical flow information set of the grid point corresponding to each to-be-processed image by performing optical flow calculation processing on a plurality of to-be-processed images in a current image processing group; and
processing the to-be-processed sphere grid model based on the optical flow information set of each grid point to obtain the target sphere grid model.

According to one or more embodiments of the present disclosure, a third example provides an image processing method, which further includes:
the obtaining the optical flow information set of the grid point corresponding to each to-be-processed image by performing optical flow calculation processing on the plurality of to-be-processed images in the current image processing group includes:
performing optical flow calculation processing on two to-be-processed images located at a same longitude in the current image processing group, and determining longitudinal optical flow information of the two to-be-processed images located at the same longitude;
performing optical flow calculation processing on two to-be-processed images located at a same latitude in the current image processing group, and determining latitudinal optical flow information of the two to-be-processed images located at the same latitude; and
determining the optical flow information set of the grid point corresponding to each to-be-processed image according to the longitudinal optical flow information and the latitudinal optical flow information of the each to-be-processed image.

According to one or more embodiments of the present disclosure, a fourth example provides an image processing method, which further includes:
the processing the to-be-processed sphere grid model based on the optical flow information set of each grid point to obtain the target sphere grid model includes:
for each to-be-processed grid region, determining a to-be-used theoretical view of each to-be-used viewpoint in a current to-be-processed grid region according to to-be-processed images of grid points of the current to-be-processed grid region and the corresponding optical flow information sets;
for each to-be-processed grid region, performing pixel processing on a to-be-used actual view and the to-be-used theoretical view at a same to-be-used viewpoint in the current to-be-processed grid region to obtain an image pixel difference value corresponding to the same to-be-used viewpoint, and determining a pixel average value according to the image pixel difference values belonging to the current to-be-processed grid region; wherein the to-be-used actual view is captured at the same to-be-used viewpoint; and
if the pixel average value is not within a preset pixel difference threshold range, re-dividing the to-be-processed grid region to which the pixel average value belongs, until the pixel average value of the to-be-processed grid region after re-dividing is within the preset pixel difference threshold range, to obtain the target sphere grid model.

According to one or more embodiments of the present disclosure, a fifth example provides an image processing method, which further includes:
if the target object is as same as the to-be-processed object, determining the target interpolation image based on a target view of each grid point in the target sphere grid model and the corresponding optical flow information set;
if the target object is different from the to-be-processed object, capturing a target view comprising the target object at each grid point in the target sphere grid model, and determining the optical flow information set of the corresponding grid point according to each target view, so as to determine the target interpolation image based on the optical flow information set.

According to one or more embodiments of the present disclosure, a sixth example provides an image processing method, which further includes:
the capturing the target view comprising the target object at each grid point in the target sphere grid model and determining the optical flow information set of the corresponding grid point according to each target view includes:
capturing the target view corresponding to the target object at each grid point in the target sphere grid model;
obtaining longitudinal optical flow information of two grid points at a same longitude in each grid region by performing optical flow calculation processing on target views of the two grid points at the same longitude;
obtaining latitudinal optical flow information of two grid points at a same latitude in each grid region by performing optical flow calculation processing on target views of the two grid points at the same latitude, and
determining a target interpolation view corresponding to the target drawing viewpoint based on the target view, the longitudinal optical flow information and the latitudinal optical flow information of each grid point.

According to one or more embodiments of the present disclosure, a seventh example provides an image processing method, which further includes:
the determining the target drawing viewpoint corresponding to the trigger operation includes:
determining target longitude and latitude information corresponding to the target object under the trigger operation as the target drawing viewpoint.

According to one or more embodiments of the present disclosure, an eighth example provides an image processing method, which further includes:
the determining the target grid region to which the target drawing viewpoint belongs based on the pre-generated target sphere grid model, and determining the target interpolation image corresponding to the target drawing viewpoint according to at least one optical flow information set of the target grid region, includes:
determining the target grid region according to target longitude and latitude information of the target drawing viewpoint; and
retrieving target views of grid points in the target grid region and at least one optical flow information set of the target grid region, and determining the target interpolation image corresponding to the target drawing viewpoint.

Furthermore, although various operations are depicted in a particular order, this should not be understood as requiring that these operations be performed in the particular order as shown or in a sequential order. Under certain circumstances, multitasking and parallel processing may be beneficial. Likewise, although several implementation details are contained in the above discussion, these should not be construed as limiting the scope of the present disclosure. Some features described in the context of separate embodiments can also be combined in a single embodiment. On the contrary, various features described in the context of a single embodiment can also be implemented in multiple embodiments individually or in any suitable sub-combination.

1. An image processing method, comprising:
determining a target drawing viewpoint corresponding to a trigger operation in response to detecting the trigger operation on a target object;
determining a target grid region to which the target drawing viewpoint belongs based on a pre-generated target sphere grid model, and determining a target interpolation image corresponding to the target drawing viewpoint according to at least one optical flow information set of the target grid region; and
sending the target interpolation image to a target client, to display the target interpolation image corresponding to the trigger operation on the target client.

2. The method according to claim 1, further comprising:
determining a to-be-processed sphere grid model, the to-be-processed sphere grid model comprising a plurality of to-be-processed grid regions;
capturing a to-be-processed image of a to-be-processed object from a viewing angle of each grid point, and determining an image processing group corresponding to each to-be-processed grid region, the image processing group comprising to-be-processed images of grid points in a same to-be-processed grid region;
for each image processing group, obtaining an optical flow information set of the grid point corresponding to each to-be-processed image by performing optical flow calculation processing on a plurality of to-be-processed images in a current image processing group; and
processing the to-be-processed sphere grid model based on the optical flow information set of each grid point to obtain the target sphere grid model.

3. The method according to claim 2, wherein the obtaining the optical flow information set of the grid point corresponding to each to-be-processed image by performing optical flow calculation processing on the plurality of to-be-processed images in the current image processing group, comprises:
performing optical flow calculation processing on two to-be-processed images located at a same longitude in the current image processing group, and determining longitudinal optical flow information of the two to-be-processed images located at the same longitude;
performing optical flow calculation processing on two to-be-processed images located at a same latitude in the current image processing group, and determining latitudinal optical flow information of the two to-be-processed images located at the same latitude; and
determining the optical flow information set of the grid point corresponding to each to-be-processed image according to the longitudinal optical flow information and the latitudinal optical flow information of the each to-be-processed image.

4. The method according to claim 2, wherein the processing the to-be-processed sphere grid model based on the optical flow information set of each grid point to obtain the target sphere grid model, comprises:
for each to-be-processed grid region, determining a to-be-used theoretical view of each to-be-used viewpoint in a current to-be-processed grid region according to to-be-processed images of grid points of the current to-be-processed grid region and the corresponding optical flow information sets;
for each to-be-processed grid region, performing pixel processing on a to-be-used actual view and the to-be-used theoretical view at a same to-be-used viewpoint in the current to-be-processed grid region to obtain an image pixel difference value corresponding to the same to-be-used viewpoint, and determining a pixel average value according to the image pixel difference values belonging to the current to-be-processed grid region; wherein the to-be-used actual view is captured at the same to-be-used viewpoint; and
if the pixel average value is not within a preset pixel difference threshold range, re-dividing the to-be-processed grid region to which the pixel average value belongs, until the pixel average value of the to-be-processed grid region after re-dividing is within the preset pixel difference threshold range, to obtain the target sphere grid model.

5. The method according to claim 2, further comprising:
if the target object is as same as the to-be-processed object, determining the target interpolation image based on a target view of each grid point in the target sphere grid model and the corresponding optical flow information set;
if the target object is different from the to-be-processed object, capturing a target view comprising the target object at each grid point in the target sphere grid model, and determining the optical flow information set of the corresponding grid point according to each target view, so as to determine the target interpolation image based on the optical flow information set.

6. The method according to claim 5, wherein the capturing the target view comprising the target object at each grid point in the target sphere grid model and determining the optical flow information set of the corresponding grid point according to each target view comprises:
capturing the target view corresponding to the target object at each grid point in the target sphere grid model;
obtaining longitudinal optical flow information of two grid points at a same longitude in each grid region by performing optical flow calculation processing on target views of the two grid points at the same longitude;
obtaining latitudinal optical flow information of two grid points at a same latitude in each grid region by performing optical flow calculation processing on target views of the two grid points at the same latitude, and
determining a target interpolation view corresponding to the target drawing viewpoint based on the target view, the longitudinal optical flow information and the latitudinal optical flow information of each grid point.

7. The method according to claim 1, wherein the determining the target drawing viewpoint corresponding to the trigger operation comprises:
determining target longitude and latitude information corresponding to the target object under the trigger operation as the target drawing viewpoint.

8. The method according to claim 1, wherein the determining the target grid region to which the target drawing viewpoint belongs based on the pre-generated target sphere grid model, and determining the target interpolation image corresponding to the target drawing viewpoint according to at least one optical flow information set of the target grid region, comprises:
determining the target grid region according to target longitude and latitude information of the target drawing viewpoint; and
retrieving target views of grid points in the target grid region and at least one optical flow information set of the target grid region, and determining the target interpolation image corresponding to the target drawing viewpoint.

9. (canceled)

10. An electronic device, comprising
one or more processors; and
a storage device on which one or more programs are stored,
when the one or more programs are executed by the one or more processors, the one or more processors realize an image processing method, which comprises:
determining a target drawing viewpoint corresponding to a trigger operation in response to detecting the trigger operation on a target object;
determining a target grid region to which the target drawing viewpoint belongs based on a pre-generated target sphere grid model, and determining a target interpolation image corresponding to the target drawing viewpoint according to at least one optical flow information set of the target grid region; and
sending the target interpolation image to a target client, to display the target interpolation image corresponding to the trigger operation on the target client.

11. A non-transient computer-readable storage medium, comprising computer-executable instructions, wherein the computer-executable instructions, when executed by a computer processer, perform an image processing method, which comprises:
determining a target drawing viewpoint corresponding to a trigger operation in response to detecting the trigger operation on a target object;
determining a target grid region to which the target drawing viewpoint belongs based on a pre-generated target sphere grid model, and determining a target interpolation image corresponding to the target drawing viewpoint according to at least one optical flow information set of the target grid region; and
sending the target interpolation image to a target client, to display the target interpolation image corresponding to the trigger operation on the target client.

12. (canceled)

13. The electronic device according to claim 10, wherein the image processing method further comprises:
determining a to-be-processed sphere grid model, the to-be-processed sphere grid model comprising a plurality of to-be-processed grid regions;
capturing a to-be-processed image of a to-be-processed object from a viewing angle of each grid point, and determining an image processing group corresponding to each to-be-processed grid region, the image processing group comprising to-be-processed images of grid points in a same to-be-processed grid region;
for each image processing group, obtaining an optical flow information set of the grid point corresponding to each to-be-processed image by performing optical flow calculation processing on a plurality of to-be-processed images in a current image processing group; and
processing the to-be-processed sphere grid model based on the optical flow information set of each grid point to obtain the target sphere grid model.

14. The electronic device according to claim 13, wherein in the image processing method, the obtaining the optical flow information set of the grid point corresponding to each to-be-processed image by performing optical flow calculation processing on the plurality of to-be-processed images in the current image processing group, comprises:
performing optical flow calculation processing on two to-be-processed images located at a same longitude in the current image processing group, and determining longitudinal optical flow information of the two to-be-processed images located at the same longitude;
performing optical flow calculation processing on two to-be-processed images located at a same latitude in the current image processing group, and determining latitudinal optical flow information of the two to-be-processed images located at the same latitude; and
determining the optical flow information set of the grid point corresponding to each to-be-processed image according to the longitudinal optical flow information and the latitudinal optical flow information of the each to-be-processed image.

15. The electronic device according to claim 13, wherein in the image processing method, the processing the to-be-processed sphere grid model based on the optical flow information set of each grid point to obtain the target sphere grid model, comprises:
for each to-be-processed grid region, determining a to-be-used theoretical view of each to-be-used viewpoint in a current to-be-processed grid region according to to-be-processed images of grid points of the current to-be-processed grid region and the corresponding optical flow information sets;
for each to-be-processed grid region, performing pixel processing on a to-be-used actual view and the to-be-used theoretical view at a same to-be-used viewpoint in the current to-be-processed grid region to obtain an image pixel difference value corresponding to the same to-be-used viewpoint, and determining a pixel average value according to the image pixel difference values belonging to the current to-be-processed grid region; wherein the to-be-used actual view is captured at the same to-be-used viewpoint; and
if the pixel average value is not within a preset pixel difference threshold range, re-dividing the to-be-processed grid region to which the pixel average value belongs, until the pixel average value of the to-be-processed grid region after re-dividing is within the preset pixel difference threshold range, to obtain the target sphere grid model.

16. The electronic device according to claim 13, wherein the image processing method further comprises:
if the target object is as same as the to-be-processed object, determining the target interpolation image based on a target view of each grid point in the target sphere grid model and the corresponding optical flow information set;
if the target object is different from the to-be-processed object, capturing a target view comprising the target object at each grid point in the target sphere grid model, and determining the optical flow information set of the corresponding grid point according to each target view, so as to determine the target interpolation image based on the optical flow information set.

17. The electronic device according to claim 16, wherein in the image processing method, the capturing the target view comprising the target object at each grid point in the target sphere grid model and determining the optical flow information set of the corresponding grid point according to each target view comprises:
capturing the target view corresponding to the target object at each grid point in the target sphere grid model;
obtaining longitudinal optical flow information of two grid points at a same longitude in each grid region by performing optical flow calculation processing on target views of the two grid points at the same longitude;
obtaining latitudinal optical flow information of two grid points at a same latitude in each grid region by performing optical flow calculation processing on target views of the two grid points at the same latitude, and
determining a target interpolation view corresponding to the target drawing viewpoint based on the target view, the longitudinal optical flow information and the latitudinal optical flow information of each grid point.

18. The electronic device according to claim 10, wherein in the image processing method, the determining the target drawing viewpoint corresponding to the trigger operation comprises:
determining target longitude and latitude information corresponding to the target object under the trigger operation as the target drawing viewpoint.

19. The electronic device according to claim 10, wherein in the image processing method, the determining the target grid region to which the target drawing viewpoint belongs based on the pre-generated target sphere grid model, and determining the target interpolation image corresponding to the target drawing viewpoint according to at least one optical flow information set of the target grid region, comprises:
determining the target grid region according to target longitude and latitude information of the target drawing viewpoint; and
retrieving target views of grid points in the target grid region and at least one optical flow information set of the target grid region, and determining the target interpolation image corresponding to the target drawing viewpoint.

20. The non-transient computer-readable storage medium according to claim 11, wherein the image processing method further comprises:
determining a to-be-processed sphere grid model, the to-be-processed sphere grid model comprising a plurality of to-be-processed grid regions;
capturing a to-be-processed image of a to-be-processed object from a viewing angle of each grid point, and determining an image processing group corresponding to each to-be-processed grid region, the image processing group comprising to-be-processed images of grid points in a same to-be-processed grid region;
for each image processing group, obtaining an optical flow information set of the grid point corresponding to each to-be-processed image by performing optical flow calculation processing on a plurality of to-be-processed images in a current image processing group; and
processing the to-be-processed sphere grid model based on the optical flow information set of each grid point to obtain the target sphere grid model.

21. The non-transient computer-readable storage medium according to claim 20, wherein in the image processing method, the obtaining the optical flow information set of the grid point corresponding to each to-be-processed image by performing optical flow calculation processing on the plurality of to-be-processed images in the current image processing group, comprises:
performing optical flow calculation processing on two to-be-processed images located at a same longitude in the current image processing group, and determining longitudinal optical flow information of the two to-be-processed images located at the same longitude;
performing optical flow calculation processing on two to-be-processed images located at a same latitude in the current image processing group, and determining latitudinal optical flow information of the two to-be-processed images located at the same latitude; and
determining the optical flow information set of the grid point corresponding to each to-be-processed image according to the longitudinal optical flow information and the latitudinal optical flow information of the each to-be-processed image.

22. The non-transient computer-readable storage medium according to claim 20, wherein in the image processing method, the processing the to-be-processed sphere grid model based on the optical flow information set of each grid point to obtain the target sphere grid model, comprises:
for each to-be-processed grid region, determining a to-be-used theoretical view of each to-be-used viewpoint in a current to-be-processed grid region according to to-be-processed images of grid points of the current to-be-processed grid region and the corresponding optical flow information sets;
for each to-be-processed grid region, performing pixel processing on a to-be-used actual view and the to-be-used theoretical view at a same to-be-used viewpoint in the current to-be-processed grid region to obtain an image pixel difference value corresponding to the same to-be-used viewpoint, and determining a pixel average value according to the image pixel difference values belonging to the current to-be-processed grid region; wherein the to-be-used actual view is captured at the same to-be-used viewpoint; and
if the pixel average value is not within a preset pixel difference threshold range, re-dividing the to-be-processed grid region to which the pixel average value belongs, until the pixel average value of the to-be-processed grid region after re-dividing is within the preset pixel difference threshold range, to obtain the target sphere grid model.
